(19) United States
(12) Patent Application Publication
(10) Pub. No.: US 2008/0072301 A1
(43) Pub. Date: Mar. 20, 2008

(54) System And Method For Managing User Authentication And Service Authorization To Achieve Single-Sign-On To Access Multiple Network Interfaces

(75) Inventors: Pei Yen Chia, Singapore (SG); Hong Cheng, Singapore (SG)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 11/631,625

(22) PCT Filed: Jul. 11, 2005
(86) PCT No.: PCT/JP05/13193

§ 371 Date: Nov. 2, 2007

(30) Foreign Application Priority Data
Jul. 9, 2004 (JP) 2004-203880

(51) Int. Cl. G06F 17/30

(52) U.S. Cl. 726/8

(57) ABSTRACT

A single-sign-on to access multiple networks residing at multiple domains is disclosed. In particular the single-sign-on features refers to the authentication and the authorization process carried out among the different network administration domains so that the terminal using the end service need not explicitly initiate the authentication process each time it accesses a new service. This invention's single-sign-on feature can be extended for usage in a federated domain environment and non-federated domain environment. The non-federated domains are able to form an indirect federation chain through other domains in order to utilize this invention. Therefore discovery of intermediate domains to form a federation chain is also covered. The management of user credentials to allow a Visited Domain to perform authentication is also covered in this invention.

### TECHNICAL FIELD

This invention relates to the field of data communication networks. In particular, it relates to the access control in the mobile telecommunication networks to achieve simpler cross-domain service provisioning. Usually a user needs to perform multiple logins in order to access the services offered by different networks in different administrative domains. This invention allows the user in a directly or indirectly federated multiple domain environment to have a single-sign-on and access the services offered by all the networks. Also, with this feature provided, it can be used for fast handover to facilitate a user to switch to a network offering the same service at any time. In an environment where multi-mode terminals are allowed, this invention is especially useful to enable the user accessing service through all the network interfaces with a single login process.

### BACKGROUND ART

To address the inefficiencies and complications of network identity management for business and consumers in today's world, there is a strong need for a federated network identity infrastructure that allows users to link elements of their identity among accounts without centrally storing all of their personal information. The today's mobile computing technology has made it possible for a user terminal to access services outside its Home Domain and not limited to accessing services within its Home Domain. Therefore multiple domain access may require a user terminal to subscribe to multiple network providers, which can be quite cumbersome for a user to maintain the multiple subscriptions. The single-sign-on feature whereby a user need maintain only one identity and need not explicitly register for services provided by other foreign domains is very attractive especially for users who are always on the go and need to access mobile services anytime anywhere.

Traditionally, single-sign-on features can be provided by password management technologies leveraging on cryptographic keys management (for example, refer to the following patent document 1, 2). One of such existing applications today is Kerberos. Kerberos is a network authentication protocol designed to provide strong authentication for client/server applications by using secret-key cryptography. The Kerberos protocol uses strong cryptography so that a client can prove its identity to a server and vice versa across an insecure network connection. Kerberos can provide the platform for single-sign-on and authentication in an open network environment. Microsoft® Windows® 2000 operating system is an example system that uses Kerberos for single-sign-on purpose. However, this single-sign-on service only provides support for upper layer applications above the operating systems. Support for single-sign-on for multiple network interfaces and multiple domains is still lacking.

There are also many other ongoing researches on providing a federated network identity infrastructure to provide single-sign-on service currently. One of such researches is the Liberty Alliance Project, which concentrates on providing a decentralized authentication and authorization from multiple service providers. The service providers mentioned at the liberty alliance project are organizations offering Web-based services to users. The issue on single-sign-on for multiple network access technology is not addressed at the liberty alliance project.

Another such research is the Shibboleth project that concentrates on the secure exchange of interoperable authorization information that can be used in access control decision. The Shibboleth project is aiming at creating a framework to support inter-institutional content sharing that is subject to access control. Similar to the liberty alliance project, Shibboleth did not address the issue of single-sign-on for multiple network access technology.

The liberty alliance project and the shibboleth project make use of the Security Assertion Markup Language (SAML) for making assertion queries to achieve single-sign-on.

There are many benefits to federated network identity infrastructure, such as
Providing the end user with a far more satisfactory online experience, as well as new levels of personalization, security, and control over identity information.
Enabling the service providers to providing resources more easily and providing access to the right resources.
Enabling businesses to create new relationships with one another and to realize business objectives faster, more securely and at a lower cost.

Therefore, a single network wide access management across multiple domains would simplify the authentication and authorization process by allowing access rights information to be distributed to trusted domains and enabling the trusted domains to perform some of the access management job. The single-sign-on feature to access different network technologies is also especially useful for multi-mode terminal that has the need to connect to different devices that operate on different network technologies. With this feature the multi-mode terminal need not perform multiple sign-ons to access the different networks each time it accesses devices that are connected via a different underlying network. Current technologies on single-sign-on address the issue of accessing application resources, but lack the ability of supporting the authentication and authorization for accessing the underlying networks technologies.

Patent Document 1: U.S. Pat. No. 6,243,816

Patent Document 2: U.S. Pat. No. 5,684,950

To access a new network, the user would be required to go through the authentication and authorization process again. These two processes would usually involve a few rounds of message exchanges between the terminal and the network. The delay caused would be large especially when the user is in a foreign domain far away from its home domain. For certain real-time application, this kind of delay would not be acceptable in the handover process. Therefore, a faster way for authorizing the user for accessing a service is necessary. In a federated multiple domain environment, it is especially so since the networks already have a trust relationship, and to ask the terminal to go through authentication in each of the networks defeats the purpose of setting up the federation in the first place.

In the current mobile computing environment, more and more terminals are equipped with multiple access technologies, e.g. Wireless LAN card, and GPRS interface, etc. For these types of terminals, accessing the multiple networks concurrently would be desired. It would not make sense for them to perform a login for each of the interface they have. A unified authentication process that enables access to all the interfaces is a straightforward requirement from them.

Nowadays, mobile networks have complicated roaming arrangements with one another. The network domain federation would also create a mesh. For example, domain A would have federations with domain B and C, and both domain B and C have federation with domain D. This would link domain A indirectly with domain D. Then, the domain A would face the problem of how to find out whether it's indirectly linked with another domain. This would require a sophisticated domain discovering method.

### DISCLOSURE OF THE INVENTION

In order to solve the above-mentioned problems, the network domains forming a federation need to agree on a pre-defined interface and protocol to collaboratively process the authentication and authorization requests from the terminal. Domains in federation would propagate the user authorization information towards the network serving the user terminal, and thus the time used for subsequent access control is reduced.

Each time a user terminal requesting an authentication, one of the network domains in the federation would be picked as the anchor point. This domain would process the request, and authorize the services accordingly by communicating with the terminal's Home Domain. A temporary certificate, the user token, would be issued by the domain acting as the anchor point to the terminal. Subsequently, the terminal could access any services provided by the domains in the federation using the temporary certificate. Local network providing the service would only need to check the certificate with the anchor point domain, which is much closer to the terminal than its Home Domain. This simplifies and accelerates the access process. On the whole, the user only needs to provide its credentials once, i.e. performing only a single-sign-on and the user is able to access multiple services at different domains. It largely reduces the possibility of revealing the user identity multiple times for each service request, and thus providing a better protection.

Also, by issuing the token to the user, no network specific service control information needs to be passed around the networks. It is easier for the networks to introduce new services to the domain federation users. Local network could have decision on the service provisioning according to the policy set for the federation.

For the domains that are not directly federated, discovery of one another in the federation chain would be important at the time of the access control. To solve this problem, the local domain serving the terminal would need to send out a query message to all the domains it is directly federated to through the predefined interface. All the domains receiving the message would cooperate and identify themselves to the local domain if they are directly federated to the Home Domain. By doing this, an indirectly federated domain could also provide single-sign-on service to the users. This kind of discovery happens only when the first user enters the local domain that is not directly federated with the Home Domain. For the subsequent users with the same Home Domain as the first user, the path identified in the discovering process could be reused. Therefore, the overhead the discovering process brought would not affect the whole system's performance.

(Operation of the Invention)

When the terminal enters a domain federation, e.g. a UMTS network, for the first time, normal authentication process would be performed. User credentials will be provided to the Authentication Controller at the local domain. The Authentication Controller would check whether there is an existing token associated with this user credentials. If none exists, it would proceed to invoke the Access Control Authority residing at the terminal's Home Domain. The Access Control Authority at the Home Domain will then authenticate this request and reply with an assertion to the Authentication Controller at the local Domain. This assertion will include subscription capability information to indicate the allowed services in this local Domain.

Once the assertion is received, the Authentication Controller would contact the associated Authorization Controller to issue a user token for the user. The Authentication Controller would also save the capability information for further usage. Once the user token is available, it would be forwarded to the user terminal. With this token, the user terminal can access the service in all the networks in the domain federation.

Whenever the terminal needs to access a service, it would provide the token with the request to the network. The network would verify the token with the Authorization Controller who issues it. If the token is valid and the capability information allows access to the service request, the network could provide the service immediately.

If a new service is introduced in the network and is not in the capability information, the token issuer would query the Access Control Authority at the Home Domain. The Access Control Authority would decide whether the service is allowed to the user based on federation policies and the user's subscriptions. Updated capability information would be forwarded to the token issuer as the reply, and subsequent service request could be directly authorized at the token issuer.

This invention allows single-sign-on feature when the terminal accesses a variety of network services provided by different network domains. Service providers could form a federation to provide services to users subscribed to any domain of the federation. This allows sharing of network resources and enable easy access to user whilst roaming into another network. User only needs to register or sign into a network domain once, and he/she would be able to enjoy the services provided by the networks or service providers that have federation relationship with the domain. The management of multiple subscriptions while performing authentication is also handled in this invention. Affiliated domains can check and validate the user authentication status, within themselves before issuing a “challenge” to the user. It reduces the processing overhead for the access control, and facilitates fast handover between networks serving the same user.

This invention provides a single-sign-on service to the user. This saves the terminal from performing multiple session initiation and if the lower layer permits, switching among network interfaces can also be easily achieved. This may enable the user to switch to a lower cost network interface during an active session. For example, during a voice conversation using a UMTS network, the terminal would have the option of switching to a WLAN network without the need to restart the session, if both networks have the invention deployed.

With the deployment of the invention, the domains could also expand the relationship to domains that not in direct federation. Using the discovery mechanism provided in the invention, the domains could form a federation chain dynamically and provide the single-sign-on services to a wider range of users.

### BRIEF DESCRIPTION OF THE DRAWINGS

FIG. 1 is a schematic view of an example of system architecture of federated environment;

FIG. 2 is a schematic view of system architecture of access to Visited Domain that is federated to Home Domain;

FIG. 3 is a sequence diagram of authentication and authorization process to achieve single-sign-on in a federated Visited Domain environment;

FIG. 4 is a Sequence diagram of authorization process making use of the user token obtained during the authentication process;

FIG. 5 is a schematic view of system architecture of access to Visited Domain that is indirectly federated to the Home Domain;

FIG. 6 is a sequence diagram of authorization process in an indirectly federated environment;

FIG. 7 is a sequence diagram of authentication and authorization process in an indirectly federated environment;

FIG. 8 is another sequence diagram of authentication and authorization process in an indirectly federated environment;

FIG. 9 is a schematic view of an example of message format (format 1) for authentication request;

FIG. 10 is a schematic view of an example of message format (format 2) for authentication assertion query;

FIG. 11 is a schematic view of an example of message format (format 3) for user token;

FIG. 12 is a schematic view of an example of message format (format 4) for authorization assertion query;

FIG. 13 is a schematic view of an example of message format (format 5) for subscription capability;

FIG. 14 is a schematic view of an example of message format (format 6) for subscription capability returned to Visited Domain 1 at step 7.4 in FIG. 7;

FIG. 15 is a schematic view of an example of message format (format 7) for subscription capability returned to Visited Domain 1 at step 7.9 in FIG. 7; and

FIG. 16 is a schematic view of an example of message format (format 8) for user identification to enable the network to select the domain for authentication.

### BEST MODE FOR CARRYING OUT THE INVENTION

A system for managing user authentication and service authorization to achieve single-sign-on to access multiple network interfaces is disclosed in this section. To help understand the invention, the following definitions are used:

A “WLAN” refers to wireless local area network. A WLAN contains arbitrary number of devices in order to provide LAN services to mobile terminals through wireless technologies.

A “3G network” refers to a 3rd generation public access network. An example could be the system defined by 3GPP or 3GPP2.

A “Mobile Terminal or MT” refers to a device used for accessing the service provided by the WLAN and other networks through wireless technologies.

A “Home Domain” refers to the network where the MT originally comes from in the inter-working scenario. A Home Domain is the place the where the MT's service subscription information is stored.

A “Visited Domain” refers to the network where the MT is attached. A Visited Domain is the network that provides access service to the Mobile Terminal.

“QoS” refers to the term Quality of Service of a data stream or traffic.

“Message” refers to the information exchanged between the Network Elements for the purpose of Inter-working control.

“Upper Layer” refers to any entity on top of the current entity that process the packet passed from the current entity.

“AAA” refers to Authentication, Authorization, and Accounting functions involved in providing service to the mobile terminal.

“AA” refers to Authentication and Authorization functions involved in providing service to the mobile terminal.

“AAA Server” refers to the AAA service provider residing at the Home Domain. AAA Server is an instance of the Access Control Authority at the Home Domain.

“AA Controller” refers to AA service provided by the Visited Domain

“Federated Domains” refers to several network service providers forming a federation or alliance with trust relationships.

“Global Authentication” refers the authentication to one network allowing user to access all other network services provided by the “federated networks”.

“Visited Domain 1” refers to the Visited Domain that is in federation with the home domain.

“Visited Domain 2” refers to the Visited Domain that is not in federation with the home domain.

In the following description, for purposes of explanation, specific numbers, times, structures, protocol names, and other parameters are set forth in order to provide a thorough understanding of the present invention. However, it will be apparent to anyone skilled in the art that the present invention may be practiced without these specific details. In other instances, well-known components and modules are shown in block diagram in order not to obscure the present invention unnecessary.

### FIRST EMBODIMENT

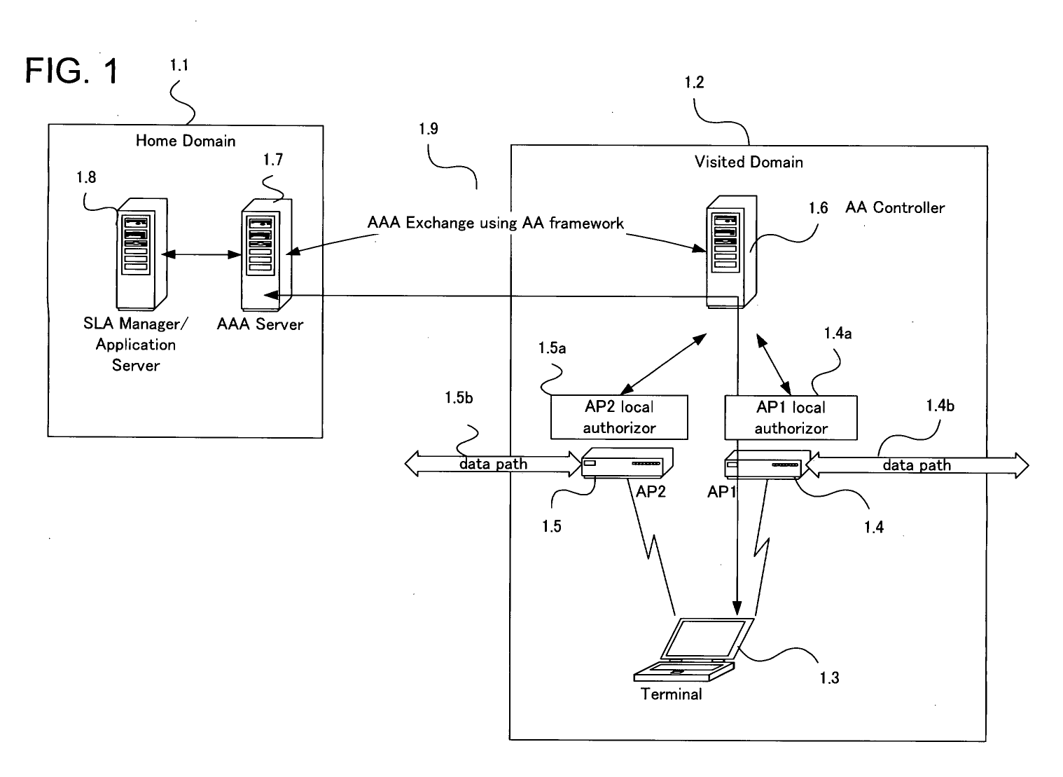

FIG. 1 shows an example embodiment of the invention that achieves global authentication in a federated network services environment. It is obvious to anyone skilled in the art that the invention could apply to any services with similar authentication architecture.

Each terminal (1.3) has a unique user identification within its Home Domain (1.1). This identification is global unique and contains the Home Domain's information. It is distributed to the user when the user associates with the domain. For example, when a user subscribes to an operator, this identification is place in the SIM/USIM card given to the user. When a user needs to authenticate himself to the Home Domain, he could use different devices, e.g. handset, laptop with a SIM reader, etc. The user could also perform simultaneous authentication using several devices. Therefore, in order to uniquely identify the user's authentication session, another authentication session identification would be generated and used in the authentication procedures. The new identification comprises the user identification for the home domain, the node identifier, and the interface identifier. With this authentication session identifier concurrent authentication procedures for the same user could be clearly differentiated.

The terminal (1.3) has a login component that can perform either an explicit or implicit login. The login component performs an explicit login by only providing user credentials for authentication. The return value for the explicit login is “authentication success” or “authentication failure” with error code. If an implicit login is performed, then both the user credentials and the service requested need to be sent out. The return value for the implicit login is “authorization success” or “authorization failure” with error code. “Authorization success” also implies successful authentication.

When the terminal (1.3) associates to an Access Point 1 (1.4), which for example can be WLAN access point, the authentication process will be automatically triggered. The WLAN access point (AP1) (1.4) that serves the terminal will be connected to the AA Controller (1.6). The AA Controller comprises the Authentication Controller and the Authorization Controller. The access point (1.4, 1.5) may or may not be on the data path (1.4b, 1.5b) of the terminal's connection. Both the Authentication Controller and Authorization Controller may be an integrated entity or split into 2 entities where the Authentication Controller processes the User Identification while the Authorization Controller assumes the role of admission control and authorizing access of resources to the terminal.

The local authorizer (1.4a, 1.5a) is assumed to be at the access point (1.4, 1.5) or somewhere that has direct control of the data connection to the terminal (1.3). The local authorizer (1.4a, 1.5a) would forward the authentication request from the terminal (1.3) to the AA Controller (1.6) of the Visited Domain (1.2). The local authorizer (1.4a, 1.5a) is provisioned with the address of the AA controller (1.6). It is also possible for the local authorizer (1.4a, 1.5a) to obtain the AA controller (1.6) address dynamically through methods such as bootstrap, DHCP, DNS, etc. The AA Controller (1.6) is the enforcer and instructs the local authorizers (1.4a, 1.5a) to open/close of ports and to allocate/release other resources. The AA Controller (1.6) also performs the resource provisioning and decides how much resource to be provided to each terminal. The local authorizer (1.4a, 1.5a) will carry out the instructions from the Authorization Controller. For subsequent discussions, it is assumed that the terminal signalling by which the terminal communicates with the AA Controller (1.6) would be transparent to the local authorizer (1.4a, 1.5a). The AA Controller (1.6) enforces multiple local authorizers (1.4a, 1.5a) within its administration domain.

In the Home Domain (1.1), there is a corresponding AAA Server (1.7), which comprises the Authentication Authority and Authorization Authority. The Home Domain's AAA Server (1.7) communicates with the AA Controller (1.6) at the Visited Domain (1.2) making use of the framework (1.9) of this invention. The AAA server (1.7) at the Home Domain will interface with the Application Server which hosts the SLA Manager (1.8) to obtain user subscription information and service level agreement of the user which resides at a centralized database. The SLA Manager (1.8) acts as an interface point between all entities to the Service Level Agreement information which is stored at the centralized database. However, a distributed database may be used as long as the SLA Manager (1.8) is able to locate the required information.

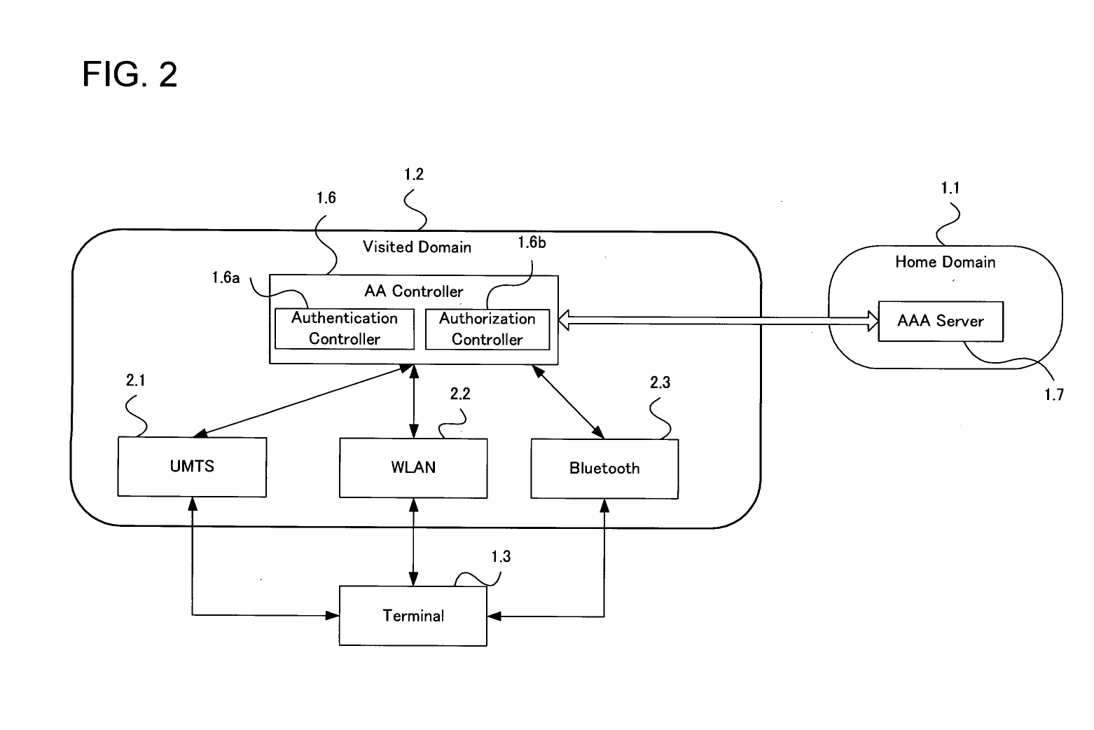

FIG. 2 shows an example of the usage of the system introduced in FIG. 1. The SLA Manager, local authorizer and the data path are not shown in this diagram for simplicity. The Authentication Controller (1.6a) and an Authorization Controller (1.6b) are controlling the authentication process and the authorization process respectively of the different network interfaces. In this diagram they are separated to indicate the different roles played by the different Controllers. This diagram shows three sub-systems being managed by the AA Controller (1.6) at the Visited Domain (1.2). The three sub-systems are the UMTS sub-system (2.1), WLAN sub-system (2.2) and Bluetooth sub-system (2.3). However, it is obvious to anyone skilled in the art that this framework can be extended to support other variations of sub-systems simultaneously. The user could use a terminal (1.3) with any or all the network access technologies to associate with any of these sub-systems and initiates the authentication process via any of these interfaces.

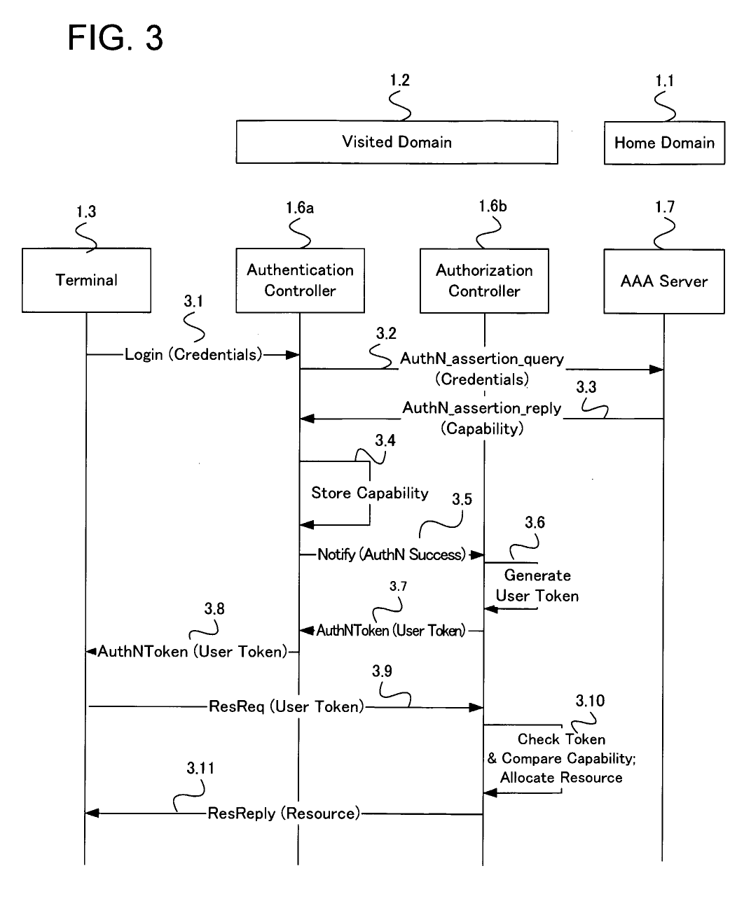

An example message exchange sequence is shown in FIG. 3 for the Visited Domain (1.2) providing a federated network interface service environment to the terminal (1.3). For example, if within the same vicinity, other services such as the 3G cellular networks (UMTS), and Bluetooth, are all federated, then if the terminal uses any of the services, the terminal will only need to authenticate itself for the first time. This framework provides the means for single-sign-on feature for a federated authentication network technology environment.

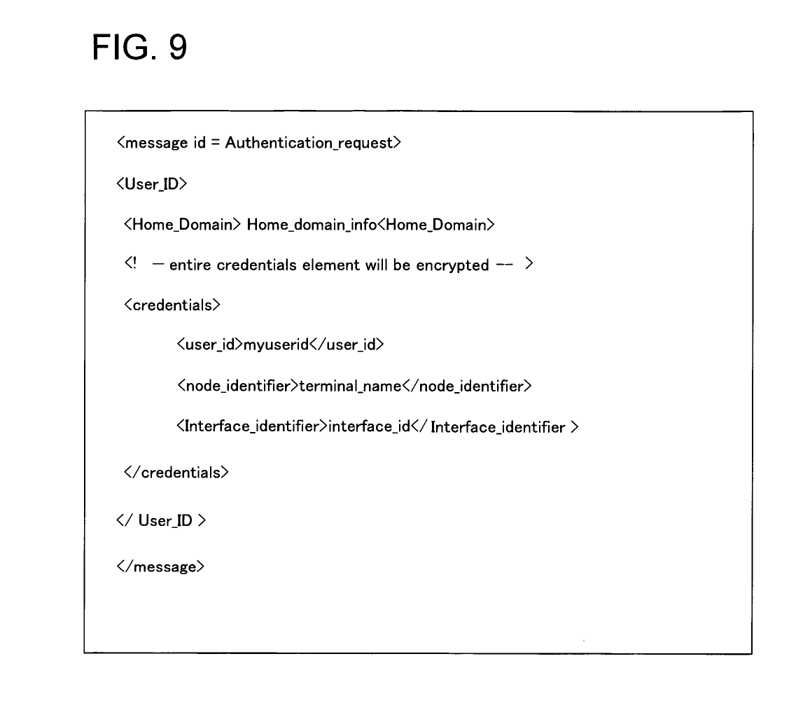

In this example, when the terminal (1.3) first associates with the Visited Domain (1.2) via the WLAN sub-system (the WLAN interface) (2.2), the terminal (1.3) presents its credentials embedded in the login message (3.1) to the Authentication Controller (1.6a) of the Visited Domain (1.2). The Authentication Controller (1.6a) will parse the login request message and extracts the credentials tag that includes the user credentials. The user credentials are in an encrypted form and not readable by the Authentication Controller (1.6a) of the Visited Domain (1.2). The information visible to the Authentication Controller (1.6a) of the Visited Domain (1.2) is the user's Home Domain (1.1) information. An example message format from the terminal (1.3) to the Authentication Controller at the Visited Domain (1.2) is shown in FIG. 9 as Format 1.

The message format is in XML. The User Identifier comprises the Home Domain information and user credentials. The entire credentials element shall be encrypted but the Home Domain information is readable. The encryption method is not shown above. The encryption algorithm is negotiated between the user and his Home Domain. This could be the information saved in the SIM/USIM card when he obtains the subscription. It also could be updated via downloadable modules after connection is established with the Home Domain. The credentials part could also include challenge or reply information if mutual authentication of the terminal and network is desired.

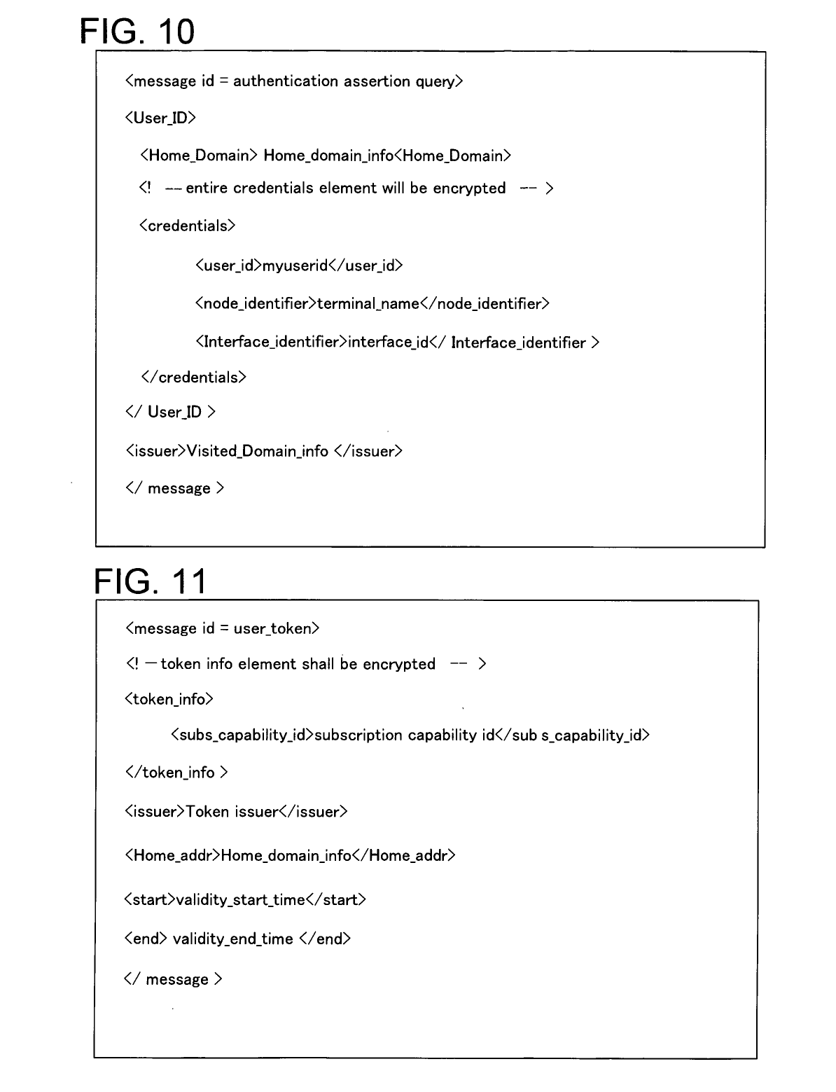

The Authentication Controller (1.6a) at the Visited Domain, making use of information of “Home_domain_info”, will then interact with the AAA Server (1.7) at the Home Domain (1.1). The Authentication Controller (1.6a) will extract the original login request message and then repackages it into an “authentication assertion query” whereby the “encrypted user credentials” will be embedded in the “authentication assertion query”. The “authentication assertion query” will then be forwarded to the AAA Server (1.7) at the Home Domain (1.1) (3.2). The issuer tag shall be the Visited Domain's information. An example of “authentication assertion query” message format is shown in FIG. 10 as Format 2.

The AAA Server (1.7) upon receiving the “authentication assertion query” message will parse the message and decrypt the user credentials using a certain preset security associations, e.g. its private key if the credentials are encrypted with its public key. The AAA Server (1.7) will then check the user credentials against its subscription profile database and authenticates the user. The user subscription profile contains information of the user identity, his personal information, the services the user is authorized to use, the Quality of Service support level, etc. It could also further contain certain policy information to be applied according to domain federation requirements. The federation policy comprises operator arrangements, e.g. service support level among domains, the number of services the federated domain is allowed to authorize to a subscriber, etc.

The reply from the AAA Server (1.7) to the Authentication Controller (1.6a) shall be an assertion success or assertion failure. The assertion success will also be replied with information on the “subscription capability” (3.3). At the AAA Server (1.7), the subscription capability information will be stored in the database for future usage (3.4). Each subscription capability has a unique identifier that points to the visited domain (1.2) that issues the “authentication assertion query” and the terminal (1.3) that issues a request. The “subscription capability” information is only intended for the Visited Domain (1.2) that forms a federation or alliance with the Home Domain (1.1). This means this Visited Domain (1.2) is a “trusted” site as seen by the Home Domain (1.1). The Authorization Controller (1.6b) at the Visited Domain (1.2) shall assess the “subscription capability” information and decide the service type, service attributes and quality of service to be rendered to the terminal.

The Authentication Controller (1.6a) at Visited Domain, upon receiving an “assertion success” reply, extracts the capability information and stores it into a database (3.4). The subscription capability has a validity period tagged to it. The validity period is the block of duration where the Visited Domain (1.2) can charge to the user account. The Authorization Controller (1.6b) will then be notified by the Authentication Controller (1.6a) on the “assertion success” (3.5). The Authorization Controller (1.6b) will then issue a user token (3.6) that is to be sent back to the Authentication Controller (1.6a) (3.7). The Authentication Controller (1.6a) will then forward the user token back to the terminal (1.3) (3.8). The terminal (1.3) will store this user token to its local database for subsequent resource request.

The format of the token shall comprise a “token_info” field which stores the “subscription capability id”. The entire “token_info” field is encrypted in the token message. Only the token issuer is able to interpret the “token_info” field which contains the subscription capability id. The user token also has a start time, end time and also the token issuer's address. Only the token issuer has the key to decrypt the “subscription capability id”, to add an additional level of security. The terminal needs only to pass back the user token in its original form for any subsequent resource request. For this message format, the “token info” tag containing information on subscription capability_id is encrypted.

All other tags are not encrypted. An example of the format for user token is shown in FIG. 11 as Format 3.

To protect malicious entities from using the token, it should be used together with some security mechanisms. One example of protecting the user token is for the token issuer to provide an initial random number together with the token. This random number would serve as a sequence number for using the token. Every time, the user needs to send out the token, it would use certain cryptography methods to generate a security code using the random number and its own credentials. For example, the user could append its security association linked with the credentials with the initial random number to form a unique number. The security code could be generated by applying hash function, e.g. MD5 on the unique number. It is obvious to anyone skilled in the art that any other cryptography methods could be utilized as long as it is pre-agreed between the user and the token issuer. It is also possible to include a field in the token and indicate the algorithm to use for the security code generation to the user. It is further possible to have this field include a list of algorithms. The user could pick from the list any of the algorithms for the code generation, and indicate the algorithm chosen in the request sent to the token issuer.

The security code would be sent together with the user token to the network for verification. The token issuer would use the same algorithm and the same information obtained in the authentication assertion to generate the verification code. Only the token with the security code that matches the verification code would be validated by the token issuer. To prevent the replay attack, the user and the token issuer would change the random number according to a pre-agreed method after every successful service request. For example, the user and the token issuer could increment the initial random number by the last 4 bits of the security association obtained earlier with the token.

Another alternative is for the terminal's Home Domain to provide a vector of security verification codes and corresponding initial random numbers in the subscription capability information embedded in the authentication assertion reply. The token issuer just sends the random number together with the token as described above, and uses the verification codes from the security vector to validate the user token. This option has the advantage that the algorithm is only known to the Home Domain and the terminal. It is easier for upgrade and poses less requirements on the token issuer.

The terminal (1.3) once equipped with a valid user token shall contact the Authorization Controller (1.6b) directly for resource authorization (3.9). The Authorization Controller (1.6b) decrypts the “subscription capability id” of the user token and compares it with the subscription capability the Authorization Controller (1.6b) has obtained earlier. If the capability gives authorization to the terminal's request, then the Authorization Controller (1.6a) shall allocate the resource accordingly (3.10) and reply to the terminal (1.3) (3.11). If the reply from the AAA Server (1.7) of the Home Domain (1.1) is “assertion failure”, then a “failure code” needs to be attached to the “assertion failure” message and to be forwarded back to the terminal (1.3).

Message passing between the Authentication Controller (1.6a) at the Visited Domain (1.2) and AAA Server (1.7) at the Home Domain (1.1) is via a secure channel. Security mechanisms, such as SSL/TLS, IPSEC, etc, could be used to provide the necessary transport layer security. If the authentication is not successful, the user will be notified of its unsuccessful attempt. This could be some displayable message derived from the “failure code” or some pre-configured message, e.g. to ask the user to try with another home domain.

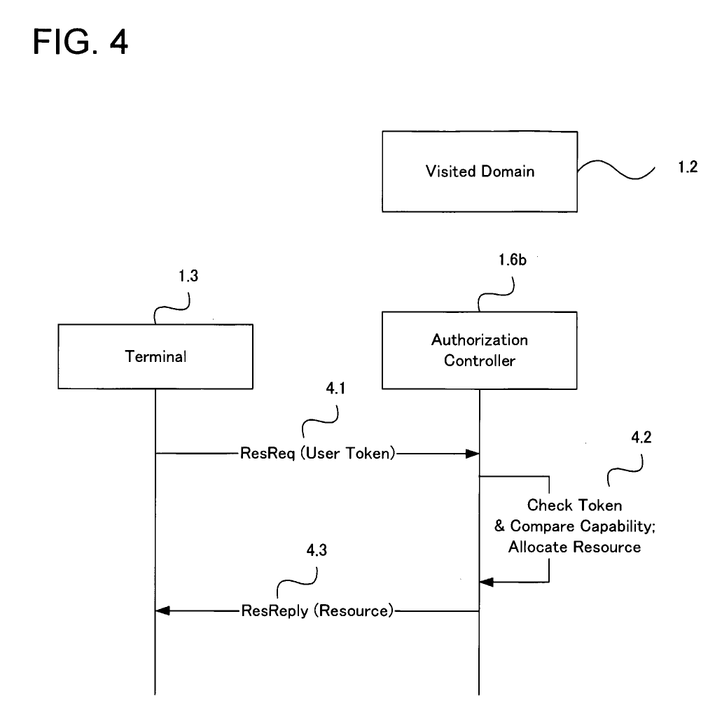

FIG. 4 shows the sequence of messages performed during explicit authorization phase. When the terminal (1.3) request for new services from the Visited Domain (1.2), e.g. the terminal (1.3) requires to use the printing services connected via Bluetooth interface (2.3), the terminal (1.3) shall initiate the authorization request embedded with the user token the terminal (1.3) has obtained during the initial authentication phase. This is assuming that the terminal has gone through steps as described in the earlier paragraphs on FIG. 3 with reference to authentication using another interface, for example WLAN Interface (2.2). The terminal (1.3) once equipped with a user token need not go through the authentication phase again, although it is now accessing a different network interface.

New requests will have to go through the Authorization Controller (1.6b). When the Authorization Controller (1.6b) has been presented with a resource request message embedded with a user token (4.1), Authorization Controller (1.6b) will first check on the authenticity of the token. The Authorization Controller (1.6b) is able to verify the authenticity of the token because it has been generated by itself during the authentication phase, but via another network interface. Based on the information of the token, the Authorization Controller (1.6b) will compare the resource request against the information of the subscription capability which has been earlier stored in the database and decides whether to grant access to the user or otherwise (4.2). If the authorization request is granted, then the Authorization Controller (1.6b) of the Visited Domain (1.2) shall instruct the Local Authorizer (1.5a) to grant the necessary local resource, and reply to the terminal (1.3) that resource is authorized (4.3). Otherwise, request failure will be sent back to the terminal (1.3).

For validating liveness, i.e. to determine the validity period of the user token, there'll be a “start time” and “end time” associated to each token. For extra level of protection, the Authorization Controller (1.6b) at the Visited Domain (1.2) may issue new user tokens to the terminal (1.3) when the token is reaching the time limit, i.e. a re-authentication process is launched for a new request when the token expires. If the user explicitly logs out, then the token shall be revoked, i.e. the terminal (1.3) cannot use the token for any further service request. Also, the subscription capability at the Authorization Controller (1.6b) of the Visited Domain (1.2) shall be deleted.

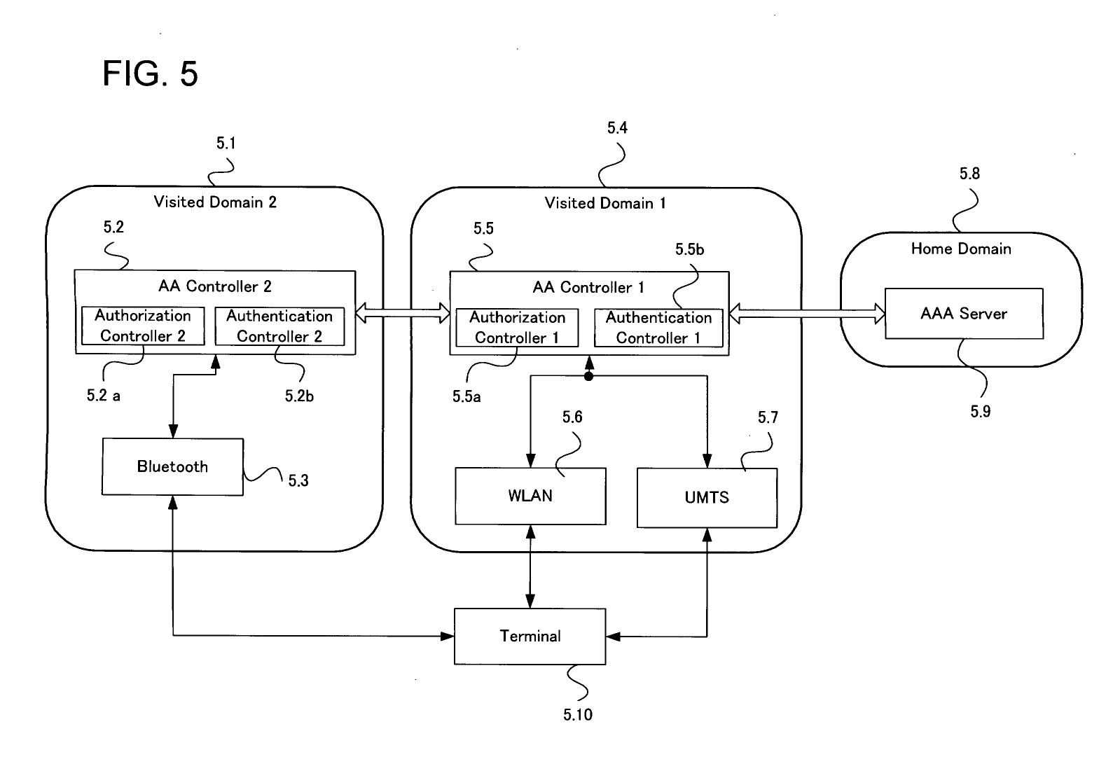

FIG. 5 shows an example of the deployment of the system architecture for another scenario whereby there are multiple Visited Domains and single-sign-on can still be achieved although there's no end-to-end federation between a Visited Domain (5.1) and the Home Domain (5.8). Each Visited Domain (5.1, 5.4) is managed by its own Authentication Controller (5.2a, 5.5a) and Authorization Controller (5.2b, 5.5b). In the diagram, only two different administration domains are illustrated. It is obvious to anyone skilled in the art that the solution can be applied to multiple visited domains too. Visited Domain 1 (5.4) is a domain that has federations with both the Home Domain (5.8) and Visited Domain 2 (5.1) separately. Visited Domain 2 (5.1) is in federation with Visited Domain 1 (5.4) but not with the Home Domain. Similar to the architecture depicted in FIG. 2, the Authentication Controller and Authorization Controller (5.2b, 5.5b) in the AA Controller (5.2, 5.5) are two dependent entities performing different roles in the control. But in implementation, these two entities could be integrated, since usually they would collocate on the same device.

As shown in FIG. 5, Visited Domain 1 (5.4) comprises the WLAN (5.6) and the 3G UMTS (5.7) sub-systems. Visited Domain 2 (5.1) comprises the Bluetooth sub-system (5.3). It is obvious to anyone skilled in the art that these two domains could contain any combination of other sub-systems. The terminal (5.10) is capable of accessing the network interfaces provided by both Visited Domain 1 (5.4) and Visited Domain 2 (5.1).

It is assumed that the terminal (5.10) has already gone through the authentication process via Visited Domain 1 (5.4) by the authentication process is similar to the process described in FIG. 3 where Visited Domain 1 (5.4) in FIG. 5 acts as the Visited Domain (1.2) in FIG. 2. For example, the terminal (5.10) originally logs on to Visited Domain 1 (5.4) via a WLAN (5.6) network interface and has gone through the same authentication procedure as described in FIG. 3.

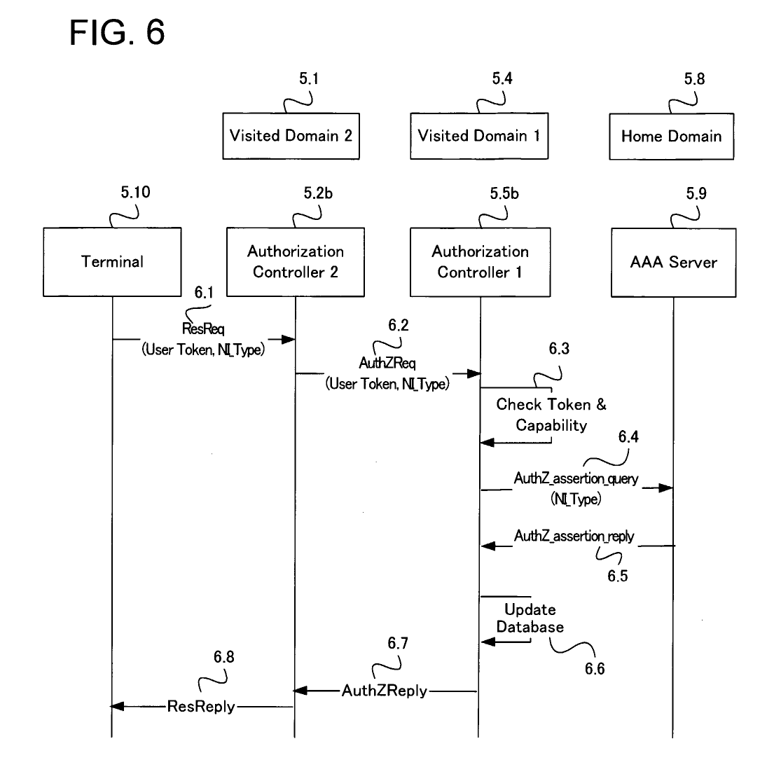

There would be situations where the terminal attempts to access service via a “third party” network interface, i.e. requesting resources from network interfaces of outside of the domain controlled by the Authorization Controller that issues the user token, e.g. the terminal (5.10) wishes to access the printing service via Bluetooth network interface (5.3) provided by Visited Domain 2 (5.1). In this case, procedures as detailed in FIG. 6 would be triggered.

The terminal (5.10) presents the “Resource request” message embedded with the user token (6.1) to the Authorization Controller 2 (5.2b) at Visited Domain 2 (5.1). It is assumed that the resource request is redirected from Authentication Controller 2 (5.2a) if terminal (5.10) only has a single point of contact in Visited Domain 2 (5.1).

The user token has been obtained earlier during the authentication phase as described in FIG. 3. The token will be tagged with the issuer's address, which in this case is the address of Authorization Controller 1 (5.5b) of Visited Domain 1 (5.4). The Authorization Controller 2 (5.2b) will query the Authorization Controller 1 (5,5b) since Authorization Controller 1 (5,5b) is the issuer of the token and they are both in alliance (6.2).

Authorization Controller 1 (5,5b) will verify the authenticity of the token, by checking on the validity period, and the id tagged to the token (6.3), etc. Then, Authorization Controller 1 (5,5b) will check with the subscription capability, which has been obtained earlier from the Home Domain (5.8), to assess whether the terminal (5.10) is allowed to use the requested service (6.3). Then Authorization Controller 1 (5.5b) will reply to Authorization Controller 2 (5.2b) of the authorization status. Since Visited Domain 1 and Visited Domain 2 are in the federation, the reply is trusted by Visited Domain 2. The message exchange between these two domains must be secure, using any scheme negotiated between them.

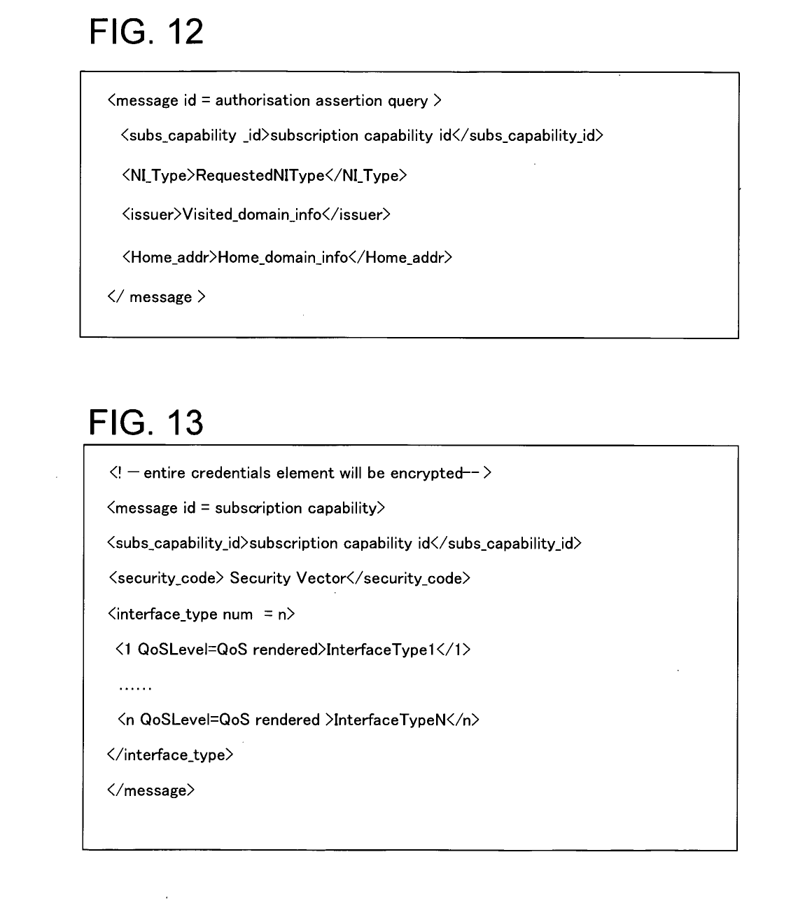

For the case if the subscription capability information does not have the network interface authorized to the terminal (5.10), then Authorization Controller 1 (5.5b) will issue a re-authorization in the form of “authorization assertion query” to the AAA Server (5.9) of the Home Domain (5.8) (6.4). The format for “authorization assertion query” is shown in FIG. 12 as Format 4.

The AAA Server (5.9) will check the new request and reply whether the terminal (5.10) has subscription to use the specified network interface (6.5). Based on the “subscription capability id”, the AAA Server (5.9) locates the subscription capability it has issued earlier and retrieves the user subscription profile. If the terminal (5.10) is authorized to use the requested network interface, then the AAA Server (5.9) will reply with an authorization success embedded with the additional capability.

The subscription capability stored by the Authorization Controller (5.5b) of Visited Domain 1 (5.4) usually contains only the network interface service provided by Visited Domain 1 (5.4) (6.3) and not the entire user subscription profile information. When new capability is received at Visited Domain 1, the database will be updated (6.6). Steps 6.4 to 6.6 will be bypassed if the earlier checking on the capability (6.3) shows that terminal (5.10) is already authorized to use the network interface. The result of the “resource request” will then be forwarded back from Authorization Controller 1 (5.5b) to Authorization Controller 2 (5.2b) (6.7). Authorization Controller 2 (5.2b) will decide whether access is granted or not to the “resource request” based on this result and also forward the result to the terminal (5.10) regarding the status of the resource request (6.8).

This invention is applicable when the Visited Domain 2 (5.1) is federated to the Home Domain (5.8). The same message protocol, shall be applied.

This invention also works when the Home Domain is the token issuer. For such cases, for subsequent access to a visited domain that is federated to the Home Domain, the same message protocol shall be applied. When the authentication is via the Home Domain, the Home Domain shall issue a token to the terminal. When the terminal tries to access a visited domain that is in federation with the Home Domain, the token will be verified by the token issuer, which in this case shall be the Home Domain.

This invention shall also be applied to the cases when the token issuer is in a federated domain and when the terminal tries to access a resource at the Home Domain. For these cases, the terminal presents the user token with the service request to the Home Domain. The Home Domain, upon receiving the user token, parses the user token that contains the Home Domain information of the terminal. When the terminal's Home Domain information is itself, the Home Domain needs to verify the authenticity of the user token with the token issuer. Upon successful verification, the Home Domain authorizes service usage according the user subscription profile instead of obtaining authorization from the token issuer which has the subscription capability information.

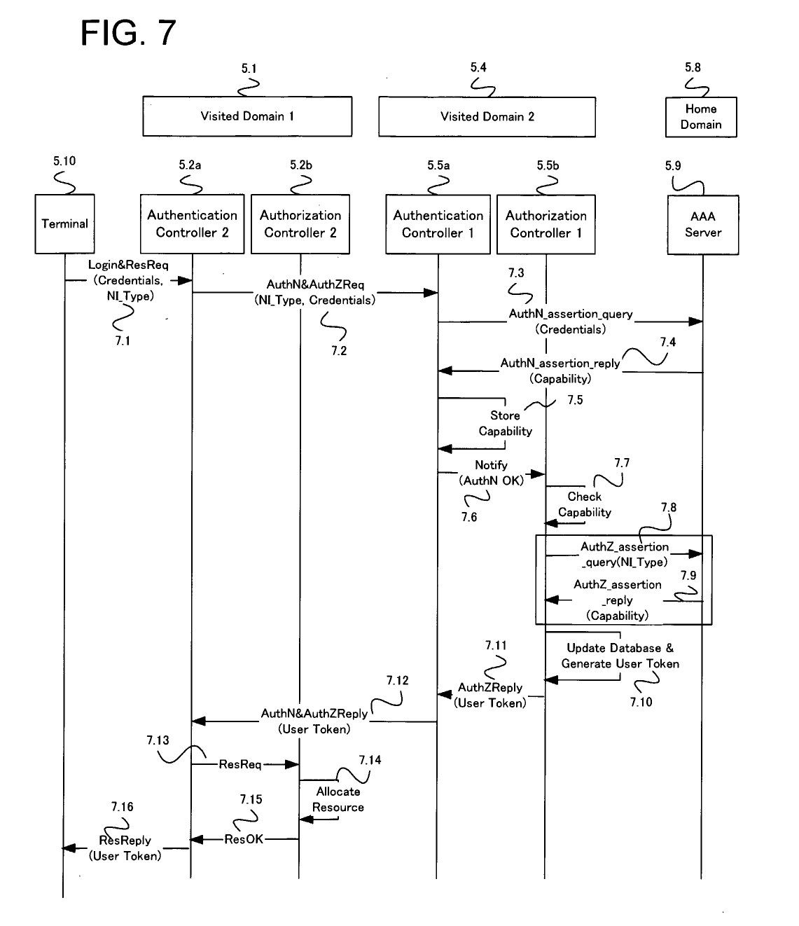

Another scenario based on the system architecture of FIG. 5 when the terminal (5.10) has not gone through the authentication process with Visited Domain 1 (5.4) before issuing the resource request to Visited Domain 2 (5.1) is shown in FIG. 7. If a terminal (5.10) starts by accessing a network interface without a valid token, then an authentication process needs to take place. If the Visited Domain that the terminal (5.10) tries to access is not in federation with the Home Domain (5.8), then the authentication process is slightly different because the Visited Domain is not considered as a trusted site, and therefore should not be presented with the knowledge of the “subscription capability” information. However, the Visited Domain may have some alliance with other networks that form an alliance with the terminal's Home Domain (5.8). Therefore, in a way, this forms an indirect alliance with the Home Domain (5.8).

The steps for authentication in this scenario are presented in FIG. 7. Visited Domain 1 (5.4) is in federation with both the Home Domain (5.8) and Visited Domain 2 (5.1). Visited Domain 2 (5.1) is not in federation with Home. Domain (5.8). The terminal (5.10) presents its user credentials which are encrypted to the Authentication Controller 2 (5.2a) (7.1). Authentication Controller 2 (5.2a) of Visited Domain 2 (5.1) checks the Home Domain (5.8) address and finds that it has no direct alliance with the Home Domain (5.8). Therefore it performs a discovery process and finds that Visited Domain 1 (5.4) has a direct alliance to the terminal's Home Domain (5.8).

In case that there are multiple domains inter-connected, there may be multiple results from the discovery process, i.e. a list of affiliated network that are also affiliated to the Home Domain (5.8). For example, the Visited Domain 2 (5.1) could also have connections to other domains that have alliance to the Home Domain (5.8) The Visited Domain 2 (5.1) could use any pre-set policy to decide which domain to route the request to. For example, connection through different domains may result in different charges, and the Visited Domain 2 (5.1) should choose the least costly domain. It is obvious other criteria could be used in choosing the domains, e.g. the load balancing, region, physical or geography distance, regulatory considerations, or a weighted combination of all the available information. Another alternative is for the Visited Domain 2 (5.1) to reply to the terminal (5.10) with a message with all the possible visited domains to use, and prompt to the terminal (5.10) to choose one. It is obvious to anyone skilled in the art that the discovery process could be implemented in many ways, e.g. a simple query to all the connected domains, a DNS lookup, a query to a MIB, etc.

After identifying the domain to use, for example Visited Domain 1 (5.4), the Authentication Controller 2 (5.2a) will issue an “Authentication and Authorization Request” to Authentication Controller 1 (5.5a) of Visited Domain 1(5.4) which is in alliance with the Home Network (5.8) (7.2). Authentication Controller 1 (5.5a) will issue the “Authentication Assertion Query” to the AAA Server (5.9) of the Home Domain (5.8) (7.3). If the Authentication Assertion Query succeeds, the subscription capability will be sent from the AAA Server (5.9) to Authentication Controller 1 (5.5a) (7.4). Authentication Controller 1 will store this subscription into the database (7.5) before notifying Authorization Controller 1 (5.5b) that the authentication phase has been completed (7.6). From the “subscription capability”, Authorization Controller 1 (5.5a) will then assess whether the terminal (5.10) is authorized to use the service provided by Visited Domain 2 (5.1). Both Authentication Controller 1 and Authorization Controller 1 are able to access the database that stores the “subscription capability”. In implementation, the Authentication Controller 1 (5.5a), the Authorization Controller 1 (5.5b) and the database can be co-located or physically separated.

Authorization Controller 1 (5.5b) will check the subscription capability against the service request (7.7). If the subscription capability message does not include the network interface that the terminal wishes to access, the Authorization Controller 1 (5.5b) will attempt to query the AAA Server (5.9) to reassert whether the terminal (5.10) is authorized to use the network interface in a third party network (7.8). If assertion success is received (7.9), then the Authorization Controller 1 (5.5b) will update the new capability in the database and issue a new user token to the terminal (7.10).

Steps 7.8 and 7.9 shall not be carried out if the subscription capability message already has information that the terminal has authorization on the requested network terminal. Step 7.10 in this case shall include generation of new user token only. Update to database will not be carried out for this case.

If authorization is given to the terminal (5.10), the user token needs to be passed back to the terminal (5.10). After generating the user token, Authorization Controller 1 (5.5b) will forward the user token back to Authentication Controller 1 (5.5a) (7.11). Authentication Controller 1 (5.5a) will then reply to Authentication Controller 2 (5.2a) with the “Authentication and Authorization Request” embedded with the user token if the request is successful (7.12). Authentication Controller 2 (5.2a) will then notify Authorization Controller 2 (5.2b) on the request status (7.13). Authorization Controller 2 (5.2b) will allocate the necessary resource (7.14) and reply to Authentication Controller 1 (7.15). Authentication Controller (5.2a) will then notify the terminal (5.10) on its request status (7.16). Subsequent access to new network interface and the procedure will be similar to that of FIG. 6.

In order to protect system's normal operation and user information confidentiality, messages are passed with security protection, e.g. Secure Socket Layer (SSL) over Transport Layer Security (TLS), IP Security (ipsec), etc. Secure tunneling is assumed to be established prior to the exchange of messages for both authentication and authorization between different AAA servers and AA Controllers of different domains. It is obvious to anyone skilled in the art that any form of security can be applied to this framework as long as sufficient security protection could be provided to the message exchanges.

The terminal could have simultaneous multiple connections activated, e.g. the terminal will be receiving his MMS through UMTS interface, at the same time, he's also downloading some files via the WLAN, which is only possible for a dual/multi mode terminals. If a terminal has access to cheaper rates from another network, it would have been informed of the alternative and need not be registered to this other network provider if the network provider is affiliated or so called in the same federation as the terminal's service provider operator. The federated network can be in a form of personalized area network if the device is within the coverage area of these networks. For example, in an enclosed area, if a terminal has logged on for WLAN service, and if the terminal decides to use the Bluetooth or infrared device, then the terminal need not log in to the different services separately.

The steps shown in FIG. 7 are only feasible for a single-tier federation discovery, i.e. the new domain the terminal tries to attach to is directly connected to a domain federated with the home domain. When that assumption does not hold, a multi-tier discovery needs to be implemented. For supporting multi-tier discovery, additional steps need to be carried out for the discovery. One method is to perform exhaustive search. This will require the multiple intermediate Visited Domains to act as proxies.

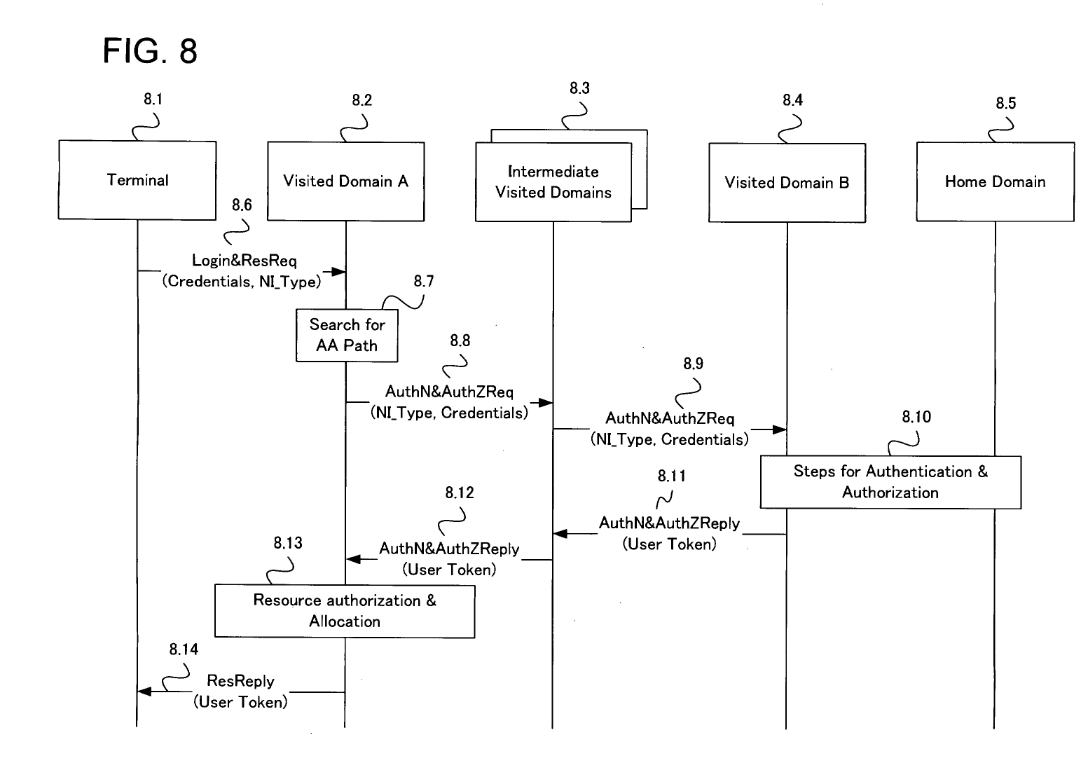

FIG. 8 shows an example of the sequence diagram for the invention in the multi-tier domain federation scenario. In FIG. 8, the terminal (8.1) first issues a “login and resource request” (8.6) and provides its user credentials to Visited Domain A (8.2), which is the domain where the terminal (8.1) would like to access its resources. Authentication Controller and Authorization Controller are not distinguished here to simplify the illustrations.

Visited Domain A (8.2) will initiate a search for a multi-tier federation process (8.7). A possible method to carry out the search is for the Visited Domain A (8.2) to send a special message containing the intended Home Domain information to all the inter-connected domains. This message would contain a life limit, and after traversing the limited number of domains, it would be discarded. When a domain receives this message, it will check whether it has federation connection with the Home Domain (8.5). If it has, this domain would inform Visited Domain A (8.2) so that Visited Domain A (8.2) forwards the request to this domain.

If the domain that receives the message does not have any relation with the Home Domain (8.5), it will decide whether to discard the message or further forward it to another domain according to local policy. Before it forwards the message, the domain would attach its own information to the message. Therefore, the message would carry the information about all the domains it traverses. This information could be used to prevent the circular forwarding. Also, it could be used later by the Visited Domain A (8.2) for forwarding the user request (8.6).

It is obvious to anyone skilled in the art that there could be other ways of doing the path search, e.g. using Domain Name Service (DNS), querying a central server, etc. The path search procedure (8.7) may return several results. In this case, the Visited Domain A (8.2) would use certain policy rules to decide which path to use, e.g. the nearest one, the most renown one, etc. Possible methods for choosing the path to use could be based on following information, e.g.
Number of Authentication Controller the request needs to traverse before reaching the Home Domain;
Physical and geography distance between the Visited Domains and corresponding Authentication Controllers;
Cost incurred by accessing the Visited Domains and the nodes;
Load status of the Visited Domains;
Service capability of the Visited Domains and corresponding Authentication Controllers;
Regulatory restrictions of the Visited Domains;
A weighted combination of the above information

It is also possible for the Visited Domain A (8.2) to return an error message to the user which contains all the related information, and prompt the user to choose a desired path.

After identifying the signalling path, Visited Domain A (8.2) will forward the “login and resource request” (8.3) to the one or more intermediate domains (8.6), which merely forwards the request to the next domain node (8.8). The path to the next domain node is known as the path that has been determined during the search and discovery. A path table can be embedded in the “login and resource request” while forwarding in order for the intermediate nodes to know which next node to forward to.

When the request finally reaches Visited Domain B (8.4) (8.9) which is in direct federation to the Home Domain (8.5), the step taken to perform authentication and authorization is performed (8.10). This step can be similar to the message exchange between Visited Domain 1 (5.4) and Home Domain (5.8) as illustrated in FIG. 7. The “Authorization Reply” will be forwarded from the Home Domain (8.5) back to Visited Domain A (8.2) using the path table in the reverse order (8.11, 8.12). Visited Domain A (8.2) will process the reply (8.13) before replying to the terminal (8.1) (8.14). The same concept of federation is still applied in this multi-domain federation environment.

### SECOND EMBODIMENT

The subscription capability (3.3, 7.4) embedded at the return message by the AAA Server comprises the authorized interface type information and the QoS level information granted to each interface type by the AAA Server to the terminal at the Visited Domain.

The authorized interface type information contains the list of the network interface type that the terminal is authorized to use at the Visited Domain. The AAA server will only include the network interface type provided by the Visited Domain that initiates the “authentication assertion query” and the network interface type subscribed by the user. For example, for the system architecture in FIG. 2, the subscription capability information returned to Visited Domain (1.2) will include “Bluetooth, WLAN, UMTS”, although the user may also subscribe to GPRS on top of the above-mentioned three network interfaces, but this will not be known to Visited Domain (1.2). This is because Visited Domain (1.2) only provides the three network interface services. The QoS level associated with each interface type is also embedded in this subscription capability information.

In another example of the system architecture in FIG. 7, the subscription capability message returned to Visited Domain 1 (5.4) shall only include “WLAN and UMTS” as Visited Domain 1 in this case only provides these two network interfaces. If the terminal (5.10) attempts to access Bluetooth interface provided by another network, Visited Domain 2 (5.1), then the Authorization Controller of Visited Domain 1 (5.4) shall seek another “authorization assertion query” specific for Bluetooth interface (5.3). If it's authorization assertion success, then the Visited Domain 2 (5.1) will notify Visited Domain 1 (5.4) to grant access to the terminal (5.10).

An example of the subscription capability message format is shown in FIG. 13 as Format 5. The entire subscription capability information should be delivered to the recipient in a secure manner, for example, using a secure channel to deliver this information. If the channel is not secure, encryption could be used to provide security. This subscription capability is embedded in the “authentication_assertion_reply” (3.3, 7.4) message and sent from the AAA Server (1.7, 5.9) back to the trusted entity that issues the “authentication_assertion_query”

The subscription capability information can also be obtained when the affiliated network issues an “authorization_assertion_query” message. The AAA Server (1.7, 5.9) will embed this subscription capability in the “authorization_assertion_reply” (6.5, 7.9). The subscription capability information returned in the “authorization_assertion_reply” is usually in reply to the “authorization_assertion_query” on a certain network interface resource.

The Security Vector field embedded in the subscription capability information is to help the receiving domain to verify the identity of the user when necessary. For example, it could be used by the Authorization Controller to verify the validity of the service request using a user token. The Security Vector could contain one security information or a list of verification codes generated by the Home Domain.

Take FIG. 7 as an example. At step 7.4, the subscription capability will contain interface type of WLAN (5.6) and UMTS (5.7) with reference to the system architecture in FIG. 5. This is because the AAA Server (5.9) knows from the federation policy that Visited Domain 1 (5.4) only provides the two network interfaces. This is despite the fact that the user may subscribe to a whole range of other services that access other network technology. This is to only present limited user subscription information to the affiliated Visited Domain which in this case is Visited Domain 1 (5.4) and not the entire user subscription information.

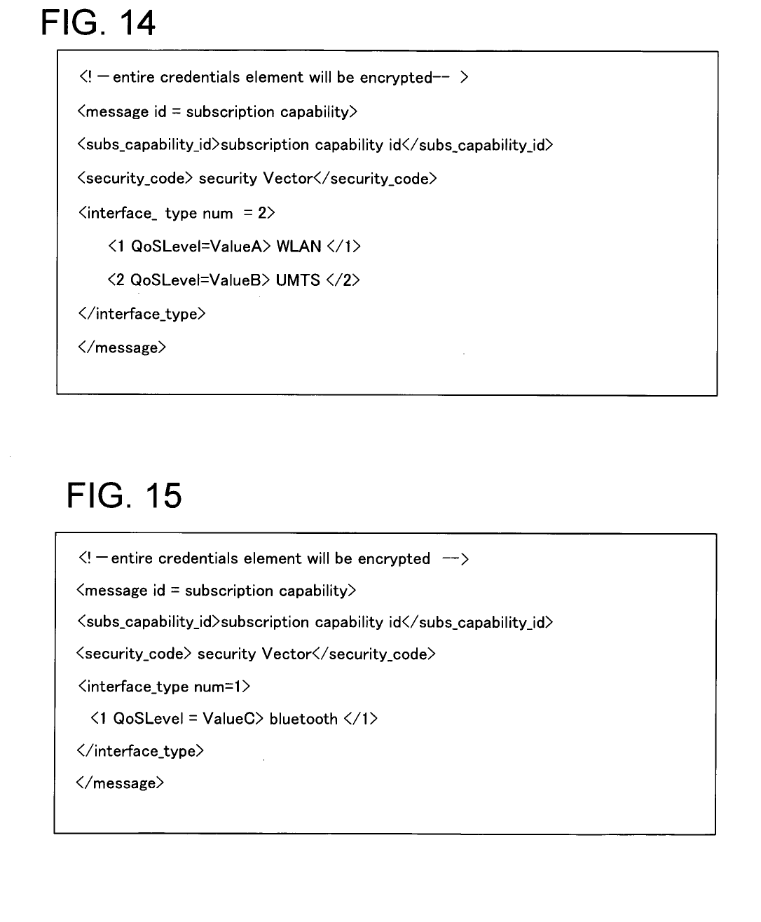

The subscription capability would be as shown in FIG. 14 as Format 6 which makes use of the template format shown in Format 5.

For each Network Interface returned, the QoS Level information is also embedded. For example, the WLAN network interface has a QoS Level that is equal to Value A. Value A comprises a list of QoS information such as minimum guaranteed bandwidth, maximum transmission rate, burst rate, jitter, maximum delay, etc. Only the interface types and its QoS levels above are illustrated. It is obvious to anyone skilled in the art that other variations of network interfaces and QoS levels are also applicable to this invention.

In step 7.8, the request is for access to Bluetooth interface. Therefore Authorization Controller 1 (5.5b) issues an “authorization_assertion_query” because Bluetooth is not in the earlier list which comprises WLAN and UMTS. Therefore the subscription capability embedded at the “authorization_assertion_reply” will contain only assertion for Bluetooth interface. The information is as shown in FIG. 15 as Format 7.

For subsequent accesses to WLAN or UMTS, Authorization Controller 1 (5.5b) which already has knowledge of the terminal's service subscription information will decide whether to grant authorization to the terminal (5.10) or otherwise when the terminal (5.10) tries to access other services that is connected via the WLAN or UMTS.

If a terminal does not subscribe to a service provided by the Visited Domain issuing the “authentication_assertion_query”, then the subscription capability will not have the service which is not subscribed by the terminal. In short, the subscription capability derived in this preferred embodiment comprises the union of network services provided by the visited domain and the network services subscribed by the terminal.

### THIRD EMBODIMENT

In the accessing of multiple domain services, it is possible that the user has multiple subscriptions. In this case, the user terminal would need to cater for multiple Home Domain scenarios, especially for the network sharing. For example, a WLAN hotspot could be owned by a domain federated with Home Domain 1 of the user, but it could also be shared by the Home Domain 2 of the user. Therefore, the user terminal must be able to choose which of the subscriptions to be authenticated with.

A way to solve this is for the Home Domains of the user to provide relevant information to the user as part of the subscription profile, e.g. save it to the USIM card given to the user. The user terminal would maintain a List of Home Domains. When the user terminal needs to access a network, it would obtain the domain information associated with the network, and compare it with the information in the Home Domain List. If the network is owned by one of its Home Domain, the user terminal would try to authenticate using the corresponding subscription from that domain. It is obvious to anyone skilled in the art that the user terminal could also set its selection criteria in choosing the Home Domain in case that there are multiple Home Domains sharing the same network. The criteria includes the rate for accessing network using the subscription, the capacity of the domain subscription, services available from the domain and its federation, the regulatory information, pre-set preference, etc. A weighted combination of these criteria could also be used. It is also possible for the user terminal to use these criteria to choose a domain not directly owning the network based on some preset policies, e.g. it would be even cheaper to access the network as a roaming user.

In the usual case, when the user terminal's Home Domain does not own the accessing network, it would be faster to authenticate the user in the local Visited Domain. Therefore, the Authentication and Authorization Controller at a domain federated with the Home Domain and near to the user terminal could download some user subscription information from the Home Domain, e.g. from the central database, and perform user authentication and service authorization locally. In this case, the user terminal should indicate in the service request that it wants to be authenticated locally, e.g. by using that federated domain as Home Domain instead of the Home Domain it subscribes service from in its authentication request.

The user terminal could obtain the information about which domain to be used as a “substitute Home Domain” through static configuration, e.g. list stored in the USIM card, or dynamic discovering, e.g. learning through previous authentication procedures. The information stored in the terminal includes a list of domains each Home Domain is federated with, and corresponding status information, e.g. cost of using the domain, regulatory information, etc. One of the ways for the user terminal to dynamically learn the “substitute Home Domain” candidates is by storing all the issuing domains of the user tokens it has ever received before. To issue a user token to the user terminal, the domain must have downloaded the user's subscription information, and had a federation relationship with the user's Home Domain. Therefore, it is safe to request to be authenticated by this domain again. It is obvious to anyone skilled in the art that there are other possible ways to discover those domains. For example, the Home Domain the user terminal has subscribed to could embed all the domains federated with itself in an authentication request reply. The terminal could retrieve that domain list from the message and store it into the Home Domain List. In case there are multiple “substitute Home Domain” candidates in the list, methods mentioned above for choosing a proper Home Domain could be reused to identify a proper “substitute Home Domain”.

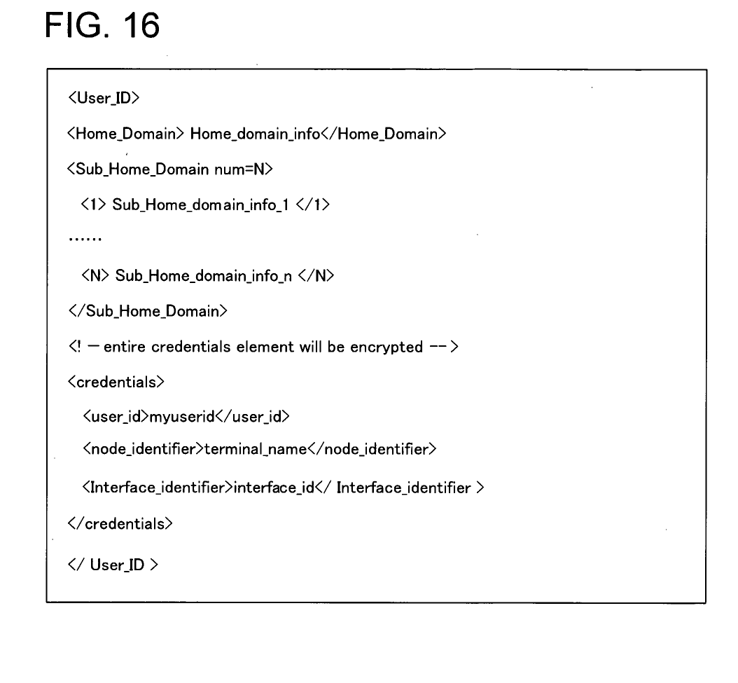

When the user terminal sends the authentication request, it could include both its Home Domain and a list of “substitute Home Domain” This will allow the Authentication Controller receiving this request to choose a proper domain of the domain at the Authentication Controller could be based on the local domain policies, federation agreements, etc. To enable this, the User_ID embedded at the authentication request must be extended to include the corresponding information. An example of the format for the User_ID field is shown in FIG. 16 as Format 8.

The user identification normally comprises user credentials and its corresponding Home Domain information. In order to support the feature of enabling the network to determine which domain to perform the authentication, a list of “substitute Home Domain” is included in the authentication request. The <Sub_Home_Domain> field in Format 8 represents the “substitute Home Domain” list. The “num” attribute shows the number of elements in this list. The first element in this “substitute Home Domain” is stored with the tag “<1>” and the second as “<2>” in increasing order until the last element in the list is labelled with “<n>” where n is the last number. It is obvious to anyone that any format for storing a list can be applied in this invention. If the domain accepting this authentication request finds itself in the “substitute Home Domain” list, then it knows that authentication can be carried out locally. If this domain can't find itself in this list, then it will select the most appropriate domain according to some pre-set criteria, e.g. distance between itself and the domain to be selected, rules in the federation policy, etc.

If the user subscription profile is not allowed to be downloaded to the federated Visited Domain, the subscription capability information can be used for service authorization. For each domain that the terminal has visited before, a record of the visit may be kept within the Visited Domain. In order for the Authentication Controller at Visited Domain to perform authentication, the terminal needs to identify itself to the Visited Domain, so that the terminal's subscription capability can be retrieved. If the terminal's original credentials are used as the identification, the Authentication Controller at the Visited Domain must have a means to decrypt the original credentials. Therefore the Home Domain needs to provide the Visited Domain with the keys to decrypt the user credentials. The user credentials and its associated user subscription capability are stored in the Visited Domain after the terminal's first visit. Therefore, when the user presents an authentication request using the same credentials, the Authentication Controller at the Visited Domain is able to recognize the credentials by searching its database. Therefore, authentication is carried out locally within this Visited Domain and service authorization can be carried out by the Authorization Controller based on the subscription capability information obtained during the terminal's earlier visit.

An alternative solution in providing faster local authentication without the need to reveal the original user subscription profile or user credentials is for the Visited Domain to provide a local user credentials to the terminal. The Authentication Controller could issue separate local credentials to the terminal. This local user credentials could be passed back to the terminal in the reply message of the Authentication request and the terminal could store this local user credentials in its local data storage or the USIM. The local credentials serve a different purpose from the user token. The user token is used throughout its validity lifetime and authentication is assumed to be successfully completed when the user token is used for service request and single-sign-on. The local user credentials are used when this terminal revisits this Visited Domain and seeks authentication again. This solution does not require the user subscription profile or original user credentials to be revealed to the Visited Domain. For example, when the terminal attempts to associate with this Visited Domain, it will search whether it has visited this domain before. If so, the terminal may attempt to use the local id provided by this Visited Domain for authentication. At the Visited Domain's end, its Authentication Controller will retrieve the user subscription capability associated with this local id and perform authentication without seeking verification from the Home Domain.

### INDUSTRIAL APPLICABILITY

This invention is applied to the field of data communication networks. In particular, this invention can be applied to the technology about access control of mobile terminal in the mobile communication network.

1. A system for managing user authentication and authorization to achieve single-sign-on for accessing multiple networks in multiple administrative domains, the multiple administrative domains being federated domains, the system comprising:
i. Access Control Authority at a user's Home Domain with the capability of maintaining user authentication and authorization status based on user subscription information, domain policies, inter-domain agreements, and user requests;
ii. Authentication Controller at an administrative domain being federated to the user's Home Domain that authenticates the user and communicates with the Access Control Authority for obtaining the user information and the domain policies; and
iii. Authorization Controller at the same administrative domain as the Access Controller that controls the user's access to services through networks in a local administrative domain and administrative domains being federated domains based on the user subscription information, the domain policies and the inter-domain agreements.

2. The system for managing user authentication and authorization according to claim 1 supporting a user accessing networks in an administrative domain which is not federated to the user's Home Domain, further comprising:
i. Authentication Controller in the local administrative domain with additional capability of discovering the Authentication Controller in an administrative domain being directly federated to the user's Home Domain and forwarding authentication requests to the Authentication Controller which is directly federated to the Home Domain; and
ii. Authorization Controller in the local administrative domain with the capability of controlling the network access and resources for the user based on the communication result with the Authentication Controller in the same administrative domain.

3. The system for managing user authentication and authorization to achieve single-sign-on for accessing the multiple networks in the multiple administrative domains according to claim 1 further comprising a Central Database at the Home Domain that stores the user's subscription information, status information, the domain policies and the inter-domain agreements.

4. The system for supporting the user accessing the multiple networks in the multiple administrative domains according to claim 1 with multiple subscriptions, further comprising a user equipment that contains a Home Domain List for storing multiple Home Domain subscription information.

5. A method for managing user authentication and authorization to achieve single-sign-on for accessing multiple networks in multiple administrative domains comprising:
i. a step in which an Access Control Authority at a user's Home Domain derives subscription capability information from a user subscription profile identified by user credentials embedded in authentication request received;
ii. a step in which an Authentication Controller at a domain being federated to the user's Home Domain stores the subscription capability information received from the Access Control Authority into a local database accessible by an Authorization Controller at the same domain;
iii. a step in which the Authorization. Controller generates a user token based on the subscription capability information, domain policies and inter-domain agreements; and
iv. a user terminal receives and stores the user token and domain information and uses those for performing subsequent network access requests.

6. The method for managing user authentication and authorization to achieve single-sign-on for accessing multiple networks in multiple administrative domains according to claim 5 further comprising a step in which the Authorization Controller encrypts the user token with security keys only known to itself.

7. The method for managing user authentication and authorization to achieve single-sign-on for accessing multiple networks in multiple administrative domains according to claim 5, further comprising:
i. a step in which the Authentication Controller receives the authentication request and verifies the relationship between of the Home Domain indicated in the request and the administrative domain the Authentication Controller belongs to;
ii. a step in which the Authentication Controller at the domain being federated to the user's Home Domain notifies an Authorization Controller in the same domain to generate the user token; and
iii. a step in which the Authorization Controller sends the generated user token to the Authentication Controller in the same domain.

8. A method for accessing services from multiple networks in multiple administrative domains with single-sign-on comprising:
i. a step in which a terminal sending a service authorization request embedding a user token generated by an Authorization Controller based on user subscription capability information to an Authorization Controller at a local administrative domain;
ii. a step in which the an Authorization Controller that generated the user token validates and decrypts the user token, and retrieves user subscription capability information from a local database using the identity embedded in the user token; and
iii. a step in which the Authorization Controller that generated the user token authorizes the service authorization request based on the subscription capability information, domain policy, and inter-domain agreements.

9. The method for accessing services from multiple networks in multiple administrative domains with single-sign-on according to claim 8 further comprising a step in which the Authorization Controller obtains the identity of the Authorization Controller that generated the received user token using information embedded in the user token and forwards corresponding service authorization request to the Authorization Controller that generated the user token.

10. The method for the Authentication Controller processing an authentication request message according to claim 7 comprising the steps of:
i. extracting the Home Domain information in the authentication request message and initiating a search for the combinations of Authentication Controllers to reach a domain being federated to the Home Domain; and
ii. selecting a combination of the Authentication Controllers from the search result to reach the domain being federated to the Home Domain using local selection criteria.

11. The method for the Authentication Controller processing an authentication request message according to claim 10, further comprising a step of forwarding the request message to the Authentication Controller at the domain being federated to the Home Domain based on the selected combination of the Authentication Controllers.

12. The method for the Authentication Controller selecting the combination of Authentication Controllers from the search result based on information according to claim 10, the information comprising:
i. number of Authentication Controller in the combination;
ii. distance between the Authentication Controllers in the combination;
iii. cost incurred by accessing the Authentication Controller in the combination;
iv. load status of the domains the Authentication Controllers in the combination belongs to;
v. capability of the Authentication Controllers in the combination;
vi. regulatory information;
vii. certain preset domain policies; and
viii. weighted combination of all the related information.

13. The method for the Authentication Controller selecting the combination of Authentication Controllers from the search result according to claim 10 comprising;
i. a step in which the Authentication Controller sends a message to the user containing all the combination and related information; and
ii. a step in which the user chooses the combination and indicates the chosen combination to the Authentication Controller.

14. The method for the Authorization Controller that generates the user token processing the service authorization request message according to claim 8 comprising the steps of:
i. comparing (a) a subscription capability information stored by an Authentication Controller with (b) the service request in the user's service authorization request;
ii. performing a re-authorization when the service request is not found in the subscription capability; and
iii. updating the subscription capability at the local database if the re-authorization result includes a new capability.

15. A method for an Authorization Controller at a domain being federated to a user's Home Domain performing service authorization without explicitly seeking authorization from the user's Home Domain, comprising the steps of:
i. retrieving the user's subscription capability obtained from a local database accessible by the Authorization Controller at a same domain where the Authorization Controller resides when a service request embedded with a user token is received; and
ii. authorizing service request based on service information of user subscription capability, domain policies and inter domain agreements.

16. A method for an Authentication and Authorization Controller at a domain being federated to a user's Home Domain performing authentication and service authorization without explicitly seeking verification from the user's Home Domain, comprising the steps of:
i. obtaining subscription capability information from the user's Home Domain by accessing database in user's Home Domain storing information;
ii. issuing a user token to the user when the user accesses a service without a user token; and
iii. authenticating and authorizing a service request from the user based on service information of subscription capability, domain policies and inter-domain agreements without contacting the user's Home Domain.

17. A method for an Authentication Controller at a domain not being federated to a user's Home Domain to authenticate a user, comprising the steps of:
i. querying among domains being federated to itself for a domain being federated to the user's Home Domain;
ii. requesting the domain being federated to the user's Home Domain to act as a service broker and perform authorization of the user's service request; and
iii. utilizing information from the service broker to decide whether to authentication the user.

18. The method for an Authentication Controller at a domain not being federated to the user's Home Domain to discover the path to a domain being federated to the user's Home Domain according to claim 10 further comprising:
i. a step in which the Authentication Controller sends query messages indicating the user's Home Domain and lifespan of the message to Authentication Controllers at domains being federated to itself according to local configurations;
ii. a step in which the Authentication Controllers receives the query message appending its own identity to the message and forwards the query messages to Authentication Controllers at domains being federated to itself if itself is not federated to the user's Home Domain indicated in the query message; and
iii. a step in which the Authentication Controller at the domain being federated to the user's Home Domain indicated in the query message appends its identity to the message and returns the message back to the originating Authentication Controller using the information attached to the message.

19. The method for protecting the user token according to in claim 5 comprising:
i. a step in which a token issuer includes a random number together with the user token in the authentication message reply sent to the user;
ii. a step in which a user terminal generates a security code using the random number and sends it together with the token in the service request;
iii, a step in which the token issuer generates the verification code using the same algorithm and verifies it with the security code received together with the token in the service request; and
iv. a step in which the token issuer and the terminal modify the random number using the same method after each service request.

20. The method for protecting the user token according to claim 5, further comprising:
i. a step in which the token issuer obtains the random number from the Home Domain and forwards random nether together with user token in the message reply sent to the user;
ii. a step in which the token issuer obtains a list of verification codes included in the subscription capability information received from the Home Domain for verifying the security codes together with the token in a service request; and
iii. a step in which the token issuer traverses through the list to obtain the correct verification code after each service request.

21. The method for the Access Control Authority at the user's Home Domain to provide to the Authentication Controller at a federated domain a limited subscription profile information of the user according to claim 5, further comprising the steps of:
retrieving network services provided by the federated domain from the inter-domain agreement;
ii. retrieving information on network services subscribed by the user from the user subscription profile;
iii, filtering out the network services that is inside user subscription profile but not allowed by the inter-domain agreement; and

22. The method for managing user authentication and authorization to achieve single-sign-on for accessing multiple networks in multiple administrative domains according to claim 5, wherein a format for subscription capability information includes:
i. a number of network interfaces a Authorization Controller receiving this message is allowed to authorize;
ii. an identifier of service profile related to Quality of Service to be rendered at each interface type the Authorization Controller is allowed to authorize; and
iii. a security code vector that contains the security information to validate subsequent messages from the terminal.

23. The method for managing user authentication and authorization to achieve single-sign-on for accessing multiple networks in multiple administrative domains according to claim 5, wherein a format for a user token includes:
i. a token issuer's address;
ii. user's Home Domain information;
iii. Time limit of the token; and
iv. subscription capability id for the token issuer to locate the subscription capability.

24. The method for managing user authentication and authorization to achieve single-sign-on for accessing multiple networks in multiple administrative domains according to claim 5, wherein a format for a domain being federated to a user's Home Domain to request for authentication assertion includes:
i. credentials of the user requesting for services;
ii. information of the domain being federated to the user's Home Domain's; and
iii. information of the user's Home Domain.

25. The method for managing user authentication and authorization to achieve single-sign-on for accessing multiple networks in multiple administrative domains according to claim 5, wherein a format for a domain being federated to a user's Home Domain to request for authorization assertion includes:
i. a subscription capability id for the subscription capability issuer to locate the user subscription profile and federation policy;
ii. service type information requested by the user;
iii. information of the domain being federated to the user's Home Domain and
iv. information of the user's Home Domain.

26. The method for managing user authentication and authorization to achieve single-sign-on for accessing multiple networks in multiple administrative domains according to claim 5, wherein a format used in an authentication request for a user terminal to indicate its credentials includes:
i. information for a domain other than the user's Home Domain to retrieve user subscription information; and
ii. A list of the domains other than the user's Home Domain where authentication process could be carried out.

27. The method for achieving fast authentication and authorization in the method to achieve single-sign-on for accessing multiple networks in multiple administrative domains according to claim 5, further comprising a step in which a user stores the token issuer's domain information in the Home Domain List for further service requests.

28. The method for achieving fast authentication and authorization in the method to achieve single-sign-on for accessing multiple networks in multiple administrative domains according to claim 5, further comprising:
i. a step in which an authentication controller at the domain that generated the user token provides a local identifier for a terminal to perform authentication request when the terminal revisits the domain that generated the user token; and
ii. a step in which the terminal uses this generated local identifier in its authentication request when the terminal revisits the local domain.

29. The method for achieving fast authentication and authorization in the method to achieve single-sign-on for accessing multiple networks in multiple administrative domains according to claim 5, further comprising:
i. a step in which the user's Home Domain provides a security association for decrypting the user credentials to a domain that the Home Domain is federated to;
ii. a step in which the domain being federated to the user's Home Domain associates this user credentials to the user's subscription capability information received from the Access Control Authority; and
iii. a step in which the local domain performs the authentication and authorization based on the user credentials and associated user subscription capability.

30. The method for achieving fast authentication and authorization in the method to achieve single-sign-on for accessing multiple networks in multiple administrative domains according to claim 5, further comprising a step in which a user replaces the Home Domain in its authentication request with another administrative domain being federated to its actual Home Domain.

31. The method for achieving single-sign-on for accessing multiple networks in multiple administrative domains according to claim 5, further comprising:
i. a step in which an Access Control Authority in the user's Home Domain embeds the domain it is federated to in the authentication reply message; and
ii. a step in which a user stores the domain information in the user equipments Home Domain List for further service requests.

32. The method for achieving single-sign-on for accessing multiple networks in multiple administrative domains according to claim 5, further comprising:
i. a step in which a user obtains the local administrative domain information from the network it's accessing;
ii. a step in which a user compares the local administrative domain information and the domain information in the Home Domain List; and
iii. a step in which a user uses one of the domains in the Home Domain List in the authentication request or service authorization request as the Home Domain based on the comparison result and some configurable policies.

33. The method for the Access Control Authority at the user's Home Domain to provide to the Authentication Controller at a federated domain a limited subscription profile information of the user according to claim 16, further comprising the steps of:
i. retrieving network services provided by the federated domain from the inter-domain agreement;
ii, retrieving information on network services subscribed by the user from the user subscription profile; and
iii. filtering out the network services that is inside user subscription profile but not allowed by the inter-domain agreement.

34. The method for an Authentication and Authorization Controller at a domain being federated to a user's Home Domain performing authentication and service authorization without explicitly seeking verification from the user's Home Domain according to claim 16, wherein a format used in an authentication request for a user terminal to indicate its credentials includes:
i. information for a domain other than the user's Home Domain to retrieve user subscription information; and
ii. A list of the domains other than the user's Home Domain where authentication process could be carried out.

35. The method for achieving fast authentication and authorization in the method to achieve single-sign-on for accessing multiple networks in multiple administrative domains according to claim 16, further comprising a step in which a user stores the token issuer's domain information in the Home Domain List for further service requests.

36. The method for achieving fast authentication and authorization in the method to achieve single-sign-on for accessing multiple networks in multiple administrative domains according to claim 16, further comprising:
i. a step in which an authentication controller at the domain that generated the user token provides a local identifier for a terminal to perform authentication request when the terminal revisits the domain that generated the user token; and
ii. a step in which the terminal uses this generated local identifier in its authentication request when the terminal revisits the local domain.

37. The method for achieving fast authentication and authorization in the method to achieve single-sign-on for accessing multiple networks in multiple administrative domains according to claim 16, further comprising:
a step in which the user's Home Domain provides a security association for decrypting the user credentials to a domain that the Home Domain is federated to;
ii. a step in which the domain being federated to with the user's Home Domain associates this user credentials to the user's subscription capability information obtained from the user's Home Domain; and
iii. a step in which the local domain performs the authentication and authorization based on the user credentials and associated user subscription capability.

38. The method for achieving fast authentication and authorization in the method to achieve single-sign-on for accessing multiple networks in multiple administrative domains according to claim 16, further comprising a step in which a user replaces the Home Domain in its authentication request with another administrative domain being federated to its actual Home Domain.

39. The method for achieving single-sign-on for accessing multiple networks in multiple administrative domains according to claim 16, further comprising:
i. a step in which an Access Control Authority in the user's Home Domain embeds the domain it is federated to in the authentication reply message; and
ii. a step in which a user stores the domain information in the user equipments Home Domain List for further service requests.

40. The method for achieving single-sign-on for accessing multiple networks in multiple administrative domains according to claim 16, further comprising:
i. a step in which a user obtains the local administrative domain information from the network it's accessing;
ii. a step in which a user compares the local administrative domain information and the domain information in the Home Domain List; and
iii. a step in which a user uses one of the domains in the Home Domain List in the authentication request or service authorization request as the Home Domain based on the comparison result and some configurable policies.
